(19) United States
(12) Patent Application Publication
(10) Pub. No.: US 2018/0089704 A1
(43) Pub. Date: Mar. 29, 2018

(54) SYSTEM FOR AUTOMATED OILFIELD SUPPLY DEMAND BALANCING AND FORECASTING

(71) Applicant: Landmark Graphics Corporation, Houston, TX (US)

(72) Inventor: Thomas Manuel ORTIZ, Houston, TX (US)

(21) Appl. No.: 15/553,162

(22) PCT Filed: Dec. 15, 2015
(86) PCT No.: PCT/US2015/065763

§ 371 Date: Aug. 23, 2017

Related U.S. Application Data
(60) Provisional application No. 62/135,574, filed on Mar. 19, 2015.

(51) Int. Cl. G06Q 30/02; E21B 41/00; G06Q 10/06

(52) U.S. Cl. CPC G06Q 30/0202; E21B 47/10; G06Q 10/06315; E21B 41/0092

(57) ABSTRACT

A method includes obtaining an available supply of a commodity using information provided by one or more commodity producers included in a network that also includes one or more commodity consumers, obtaining a demand for the commodity using information provided by the one or more commodity consumers, controlling the available supply of the commodity from the one or more commodity producers using information provided by the one or more commodity consumers, and supplying the commodity to the one or more commodity consumers based on the demand for the commodity.

### CROSS-REFERENCE TO RELATED APPLICATIONS

This application claims priority under 35 U.S.C. § 119 to Provisional Application No. 62/135,574 filed on Mar. 19, 2015, in the United States Patent and Trademark Office.

### BACKGROUND

Existing commodity demand and supply networks exchange information including consumer demand and the supply to meet the demand. The networks also forecast consumer demands and commodity producers adjust the commodity production based on the demand forecasts. However, adjusting the production may result in a change in the quality or composition of the commodity being demanded, which requires a change in the commodity processing facilities (e.g., refineries). Presently, commodity producers do not provide the quality or composition of the commodity in advance so that the commodity processing facilities may be modified in time to meet the demand. This may result in a delay in meeting the demand and result in an increase in commodity pricing.

Also, the consumer demand does not take into consideration the amount of commodity available in storage or the amount of available storage capacity prior to producing demand forecasts and requesting an adjustment in the commodity production. This may also result in an undesirable change in the commodity pricing.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 illustrates an exemplary network of commodity producers and commodity consumers.

FIG. 2 illustrates a flow chart of an exemplary process of balancing a flow of one or more commodities in the network of FIG. 1 using information communicated by nodes of the network of FIG. 1.

FIG. 3 illustrates an exemplary processing system for configuring and/or controlling the operations of one or more of the commodity producers, the commodity consumers, and/or the separation and blending facilities in the network of FIG. 1.

### DETAILED DESCRIPTION

The present disclosure is related to optimizing the delivery of crude oil, water, and/or natural gas from one or more production facilities (e.g., producing wells or fields) to a connected group of consumption and/or support facilities (e.g., tank batteries, export pipelines, tankers, storage terminals, refineries, gas processing facilities, disposal sites, and injection wells). The present disclosure may utilize real-time information about historical and current production volumes, available injection gas volumes, capacities of water and gas processing facilities, storage capacity, customer demand, reservoir pressure maintenance targets and the like in order to balance supply and demand for meeting these competing objectives. The present disclosure may provide two-way communication between supply-side and demand-side (delivery) models, so that production is optimized to meet anticipated demand, and so that demand expectations correctly account for limitations in or changes to production.

The present disclosure combines a supply-demand network balancing system and a product sales and supply logistics optimization system with an oilfield production optimization and forecasting system to obtain a composite communication network. The supply-demand network balancing system and the product sales and supply logistics optimization system may change product composition or quality in real-time or near real-time. The composite communication network may calculate and/or predict changes to the production forecast for the well/field network. The changes may include, for example, artificial lift constraints, rising water cut, and/or changes in gas/oil ratio (GOR) and may be calculated/predicted using petroleum engineering models.

In some embodiments, the composite communication network communicates the production forecasts to demand-side workflows. The demand-side workflows may correlate the production forecasts with commodity pricing and customer demand forecasts that match predicted product composition or quality. In this way, a refinery may be prepared in advance for a change in product mix, and its systems may automatically compensate to accept the changed product. Facilities, such as water or gas injection plants, gas flares, or water treatment and disposal plants, each of which consumes production fluids to serve the production network, may communicate their capacities to the production system and request changes in supply when required (e.g. request a reduction in supply during maintenance shutdowns).

A self-discovering network of sensors, valves, and flow meters may enable the complete automation of the exemplary composite communication network through supply (production) and demand (export or consumption) balancing. For example, flow meters may sense a reduced availability of lift gas and may trigger reduction of production from certain wells and an increase in production of different wells (in either the same or a different field) in a way that may meet the aggregate demand requested from all connected consumption facilities. The consumption facilities may continuously broadcast their demands to the composite communication network, and may trigger reductions or increases in production based on demand changes. For example, a delay in tanker loading that is coupled with a shortage in available storage capacity may trigger the reduction of the least valuable (e.g. highest water cut) wells serving the tanker loading terminal. The exemplary composite communication network may therefore permit oil and gas producers to efficiently manage the production, sale, and/or distribution of their products.

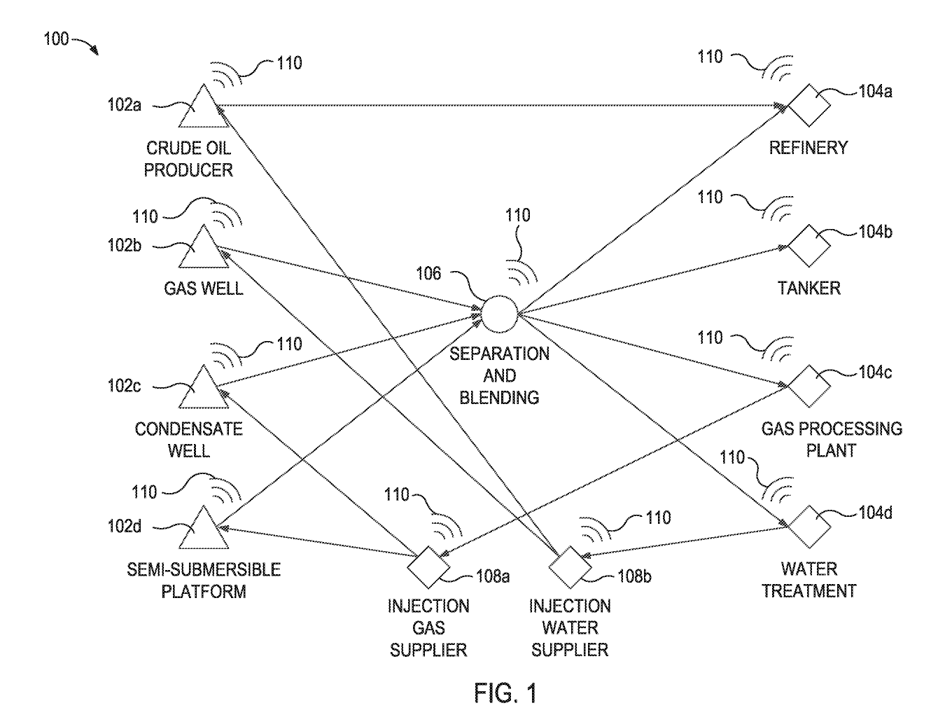

FIG. 1 illustrates an exemplary network 100 of commodity producers and commodity consumers, according to one or more embodiments disclosed. As an example, the commodity producers may include oil wells, gas wells, condensate wells, off-shore drilling facilities, and the like. The commodity consumers may include oil or petroleum refineries, gas processing plants, oil tankers, chemical tankers, gas carriers, water treatment facilities, injection water suppliers, injection gas suppliers, water disposal plants, chemical plants, offshore oil and gas rigs, landfills, and the like.

In the network 100, the commodity producers may be represented by producer nodes 102a-102d (collectively referred to as producer nodes 102) and the commodity consumers may be represented by consumer nodes 104a-104d and 108a-108b (collectively referred to as consumer nodes 104, 108, respectively). As illustrated, the producer nodes 102 may include a crude oil producer 102a, gas well 102b, condensate well 102c, and semi-submersible platform 102d. The consumer nodes 104 may include a refinery 104a, a tanker 104b, a gas processing plant 104c, and a water treatment facility 104d. The consumer nodes 108 may include an injection gas supplier 108a and an injection water supplier 108b. It should be noted that injection gas supplier as used herein may refer to any facility that supplies gas including, but not limited to, produced gas, carbon dioxide (CO₂), etc., that is used for enhanced oil recovery (EOR) or enhanced gas recovery (EGR) techniques. Although not expressly illustrated, the consumer nodes 108 may include water or gas disposal plants, or any facility that receives its inputs from one or more consumer nodes 104 and provides its outputs to one or more producer nodes 102. The consumer nodes 104 may be referred to as “primary” consumer nodes since the consumer nodes 104 receive the outputs of one or more producer nodes 102. The consumer nodes 108 may be referred to as “secondary” consumer nodes, since these nodes receive the outputs of one or more of the “primary” consumer nodes 104. The outputs of the consumer nodes 108 may be provided to the producer nodes 102.

For example, as illustrated in FIG. 1, an injection water supplier (consumer node 108b) may provide injection water to a crude oil producer (producer node 102a) for enhanced oil recovery (EOR) techniques, such as water flooding or steam injection. The injection water may be obtained by the injection water supplier from a “primary” commodity consumer such as a water treatment facility (consumer node 104d). The water treatment facility may in turn receive water for treatment from a commodity consumer such as a crude oil producer 102a.

As illustrated, the production fluids (e.g., crude oil, natural gas, wet gas, etc.) output from the producer nodes 102 may be provided to the consumer nodes 104 via one or more separation and blending nodes 106 (one shown). The separation and blending node 106 may represent one or more facilities that operate to separate individual fluidic components (e.g., water, gas, crude oil, etc.) from a received production fluid, or may mix two or more received production fluids to create one or more blended fluids. Alternatively, the blending and separation operations may be performed “on-site” by one or more of the producer nodes 102, and the outputs thereof may be provided directly to one or more consumer nodes 104. For example, in FIG. 1, a crude oil producer (producer node 102a) outputs production fluids directly to the refinery (consumer node 104a).

It should be noted that the number of nodes 102a-102d, 104a-104d, 106, 108a-108b in the network 100 of FIG. 1 is merely an example, and that the number of nodes may be increased or decreased based on the application and design requirements. For example, as new reservoir or formations are discovered, these may be included in the network 100 as new producer nodes 102. Additionally, as new hydrocarbon processing facilities are built or included, or injection fluid suppliers are identified, these too may be added to the network 100 as consumer nodes 104, 108.

Each of the nodes 102, 104, 106, 108 may transmit information regarding its current and/or forecasted ability to either produce or consume a commodity, and this information may be received by the other nodes in the network 100. This information may also include the type of commodity that may be produced or consumed. For instance, a crude oil producer (producer node 102a) may indicate the amount and type (e.g., light oil, medium oil, heavy oil, sweet oil, sour oil, etc.) of crude oil currently being produced or the forecasted amount and type of crude oil that may be produced. A refinery (consumer node 104a) may indicate the amount and type of crude oil it can currently process or its future capability of processing a certain type of crude oil. A tanker (consumer node 104b) may indicate a current or future crude oil carrying capacity, or any change in the estimated time of arrival (or departure) at a facility such as a port. A gas processing plant (consumer node 104c) may indicate the amount and type of gas currently being processed. The injection gas supplier (consumer node 108a) and the injection water supplier (consumer node 108b) may indicate the amount of injection gas or injection water currently available or the forecasted future capacities. The separation and blending node 106 may indicate the compositions of the individual fluidic components separated from a received production fluid or may indicate the composition of the one or more blended fluids created by mixing two or more received production fluids. The separation and blending node 106 may also communicate the fluid properties such as pressure, volume, temperature, density, thermal conductivities, viscosity, conductivity, surface tension or any other property desired by the producer nodes 102 and consumer nodes 104, 108.

As illustrated generally at 110, the nodes 102, 104, 106, 108 may communicate the respective information at or near real-time over a wired medium, a wireless medium, or a combination thereof so that most recent information may be available. The information may be communicated either continuously or at desired intervals. In an example, a node of the network 100 may broadcast the corresponding information and the information may be received by all other nodes of the network 100. Alternatively, a node may transmit information exclusively to one or more other nodes of the network 100, and these nodes may exclusively communicate with each other. It should be noted that communication may not be only between producer nodes 102 and consumer nodes 104, 108, or between producer nodes 102 and separation and blending nodes 106, or between consumer nodes 104, 108 and separation and blending nodes 106. Two or more producer nodes 102 may also communicate with each other. Likewise, two or more consumer nodes 104, 108, or two or more separation and blending nodes 106 may also communicate with each other.

As a result, a node of the network 100 may have real-time information about the other nodes and about the commodities being produced and the consumed throughout the network 100. The current and/or forecasted commodity production can be communicated to consumer nodes 104, 108, which may then correlate the current and/or forecasted commodity production with commodity pricing and/or customer demands to match predicted commodity composition or quality. In order to do so, the consumer nodes 104, 108 may request rebalancing of the flow of commodities, deferring the production of certain commodities, and/or increasing production and throughput of certain other commodities.

The forecasted commodity production may also enable one or more consumers nodes 104, 108 to be configured in advance of accepting the commodity. For instance, a refinery 104a can be configured in advance based on a forecasted change in composition or quality of commodity that may be received in order to accept the changed commodity. As a result, the time spent in configuring the refinery 104a after receipt of the commodity is reduced. Alternatively, if the refinery 104a cannot be configured in time to accept the changed commodity, the supply of the changed commodity to the refinery 104a may be reduced (or shut off) until the refinery 104a can accept the changed commodity. In the meanwhile, the changed commodity can either be stored or diverted to other consumer node(s) 104b-104d that can accept the changed commodity.

Likewise, based on the current and/or forecasted commodity production information, consumers nodes 104, 108, such as injection gas supplier 108a, injection water supplier 108b, or water treatment plant 104d, that consume produced fluids to serve the producer nodes 102, such as crude oil producer 102a and gas well 102b, can communicate their respective capacities to the crude oil producer 102a and gas well 102b and request reductions in commodity supply when appropriate, for example, during maintenance shutdowns. For instance, an injection gas supplier 108a may request a gas plant 104c reduction in supply of injection gas provided during a shutdown of the facility. In turn, the gas plant 104c may store injection gas until the supply to the injection gas supplier 108a is resumed, reroute the injection gas to other injection gas supplier, or dispose of (flare) the injection gas. Additionally or alternatively, the gas plant 104c may request a reduction in supply of gas from one or more commodity producers 102.

In some examples, a commodity of a certain quality (e.g., sweet gas) may be currently supplied from a gas well 102b to a tanker (gas carrier) 104b and a gas processing plant 104c. If the gas processing plant 104c indicates an increased requirement for sweet gas, the flow of sweet gas in the network 100 may be rebalanced such that a supply of sweet gas to the gas processing plant 104c may be increased and the supply to the tanker 104b may be reduced. This may result in increased revenue since a higher price may be obtained for the sweet gas from the gas processing plant 104c.

In other examples, if the gas processing plant 104c indicates an increased availability of gas, the excess gas may be provided to the gas injection supplier 108a that may store the gas for future use or redirect the gas to one or more commodity producers (nodes 102). Similarly, the water treatment plant 104d may divert any excess water to the injection water supplier 108b, which may store the water or resupply the water to one or more commodity producers (nodes 102).

In one or more embodiments, a variety of petroleum engineering models may be included in the network 100 estimate or predict the amount of hydrocarbons that may be produced from a formation. These models may operate either independently or in conjunction with one or more commodity producers of the network 100. For example, one of the petroleum engineering models may be a reservoir model that may provide the structure of a subsurface formation and, based on the structure, predict the flow of hydrocarbons (commodity) in the formation, the amount of hydrocarbons that may be located in the formation, and/or the amount of hydrocarbons that can be produced over time. A producing node 102 utilizing this model may communicate this information obtained from the reservoir model to other nodes in the network 100. In another example, a wellbore model may also be used to indicate the production capacity of an individual well. The wellbore model may take into consideration, for example, the physical characteristics of the completed well, the pressure required to be maintained for safe operations, the pressure losses in the well, etc. in order to estimate an amount of hydrocarbons that can be produced.

Other engineering models that may be used include a thermodynamics model that may predict the property of produced fluids based on their composition, and a pipe flow model that may estimate the amount of fluid that can flow between the nodes 102, 104, 108 of the network 100 based on the topology of the piping network interconnecting the nodes. It should be noted that the above-mentioned engineering models are merely examples of a variety of petroleum engineering models that may be used to calculate and predict changes to the commodity production forecasts. It will be understood that other desired engineering models may alternatively be used without departing from the scope of the disclosure. Additionally, in the event that new models are discovered or current models are revised, these may be added to the network 100.

Although not expressly illustrated, in order to control and/or regulate the flow of commodities in the network 100, the piping network interconnecting the nodes 102, 104, 108 may include a variety of controlling devices and/or regulating devices installed in the network 100. Exemplary controlling devices and/or regulating devices include, but are not limited to, sensors (e.g., chemical, pressure, flow, temperature, and level sensors), flow control devices (e.g., valves), and metering devices (e.g., flow meters, gauges, etc.). These controlling and/or regulating devices enable the complete automation supply (production) and demand (export or consumption) balancing. For example, flow meters sensing a reduced availability of injection gas may trigger the choking back of production from one or more producing nodes 102 and an increase in production from one or more other producing nodes 102 in a way that meets the aggregate demand requested from the consumer nodes 104, 108. As mentioned above, the consumer nodes 104, 108 broadcast their demands to the network 100, and, as a result, can trigger reductions or increases in production based on demand changes. For example, a delay in tanker loading that is coupled with a shortage in available storage capacity can trigger the choking back of production of one or more commodities from one or more producer nodes 102 serving the tanker loading terminal until a tanker is available for loading or sufficient storage facilities are available. Generally, the production of commodities having a reduced demand (or reduced costs) may be cut back.

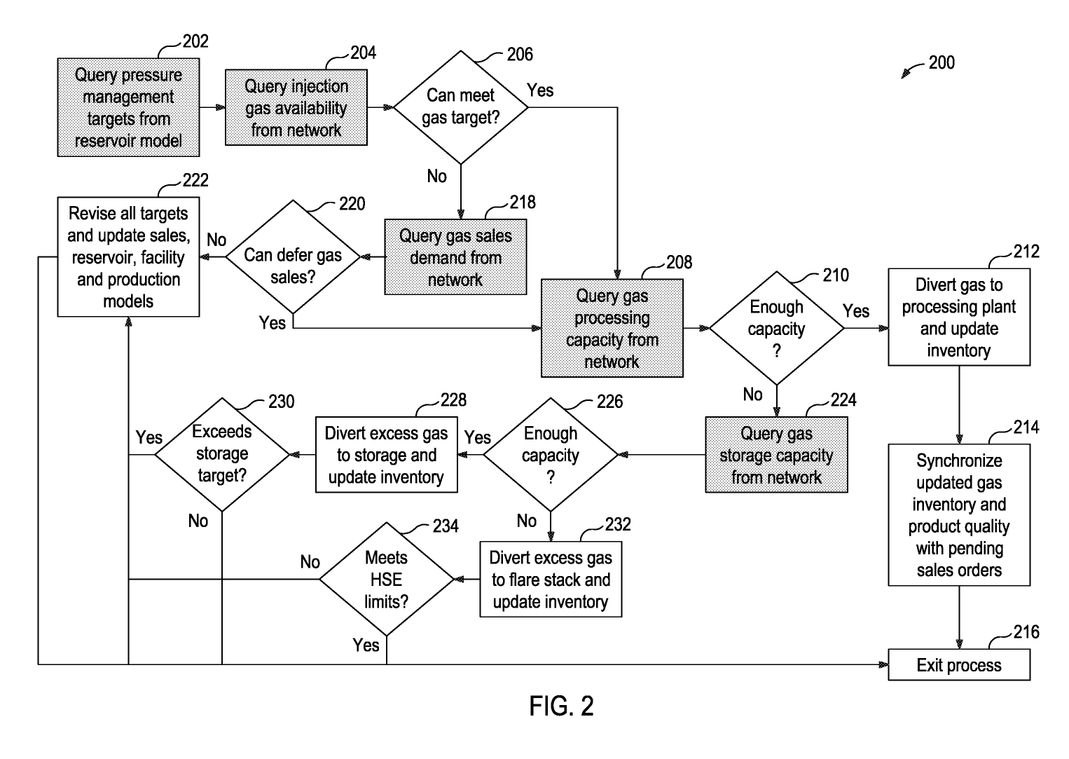

FIG. 2 illustrates a flow chart of an exemplary process 200 of balancing a flow of one or more commodities in the network 100 of FIG. 1 using information communicated by the nodes 102, 104, 108 of the network 100 of FIG. 1. The process 200 may optimize the timing and rate of production of one or more commodities from the producer nodes 102 in FIG. 1. For the sake of explanation, the exemplary process 200 of FIG. 2 has been described with respect to managing gas flow within the network 100. However, as will be understood, this is merely an example and the exemplary process 200 is not restricted thereto and may be used to manage the flow of other commodities between the producer nodes 102 and the consumer nodes 104, 108 of the network 100 of FIG. 1. For example, the process 200 may also be used to balance water demand for pressure maintenance against treatment capacity and cost, balance crude oil demand while fulfilling requests from connected refineries, tanker terminals, pipelines, and/or storage facilities, or balance any commodity that may be produced in the network 100.

Referring to FIGS. 1 and 2, the producer nodes 102 and the consumer nodes 104, 108 may broadcast the respective injection gas capacity, gas sales demand, gas processing capacity, and/or gas storage capacity. As mentioned above, flow balancing in the network 100 may be based on the predictions/estimates obtained from one or more engineering models. In the process 200, a reservoir model may be utilized, which may communicate the pressure required to be maintained in one or more gas wells (producer nodes 102) for effective production of gas (also referred to as the pressure management target).

The shaded boxes 202, 204, 218, 218, and 224 may represent a producer node 102 representing the various commodity producers or an engineering model, and may communicate current and/or forecasted commodity production information to one or more other nodes 102, 104, 108 and/or to any engineering models associated with the other nodes. The process 200 may ensure optimum flow of commodities between the commodity producers and commodity consumers.

The process 200 may also assist with budgeting based on the current and/or forecasted commodity production information. For example, based on the gas demand forecasts, gas storage capacity may be built or leased at the most economical times in order to meet forecasted demands. This is because the gas demand forecasts may reflect pricing assumptions, and revenue optimization may be incorporated into the process of balancing gas flows.

In describing the exemplary process 200, it is assumed that the process 200 may be triggered at 202 by querying a reservoir model of a gas well to obtain the reservoir pressure required to maximize production of gas from the gas well. Assuming that injection gas is used to pressurize the reservoir, at 204, one or more injection gas suppliers 108a of the network 100 may be queried to determine availability of gas for injection purposes. Based on the gas availability provided by the injection gas suppliers 108a, it is verified whether the amount of gas available is sufficient to meet the required reservoir pressure targets, as at 206. If a sufficient amount of gas is available, then the process 200 queries one or more gas processing plants 104c for their processing capabilities to process gas that is leftover after using for injection purposes, as at 208. If it is determined that the gas processing plants 104c have the required gas processing capability, as at 210, then, as at 212, the gas is supplied to the gas processing plants 104c for processing, and the amount of gas available in the network 100 is updated. Using the updated gas inventory and the quality or composition of the produced gas, the pending orders may also be updated and/or revised, as at 214. The process 200 then ends at 216.

If, at 206, it is determined that the amount of gas available is not sufficient to meet the required reservoir pressure, then, as at 218, the process 200 may request for gas intended for future sale (e.g., future gas sales contracts, agreements, etc.) from one or more producer nodes 102 and/or consumer nodes 104. If any gas sales can be deferred, as determined at 220, the gas from the deferred sales is redirected for injection purposes and the process 200 again queries gas processing plants 104c for processing capabilities to process gas that is leftover after using for injection purposes, as at 208. If, at 210, it is determined that the gas processing plants 104c have the required gas processing capability, then the excess leftover gas is diverted to the gas processing plants 104c for processing, and the process continues as at 212.

If the pending sales/demands may not be deferred, as determined at 220, then the process 200 may include revising the pressure management targets, updating the sales, and/or updating the reservoir model (or any other engineering model), as at 222, before exiting at 216. If, at 210, it is determined that the required gas processing capacity is unavailable, the process 200 queries whether adequate gas storage capacity is available to store the gas for later processing, as at 224. If, at 226, it is determined that adequate storage capacity is available, the produced gas is diverted to storage and inventory is updated, as at 228. The process 200 also checks whether any storage targets are exceeded, as at 230. If the storage targets are exceeded, the process 200 may revise the pressure management targets, update the sales, and/or update the reservoir model (or any other engineering model), as at 222, before ending at 216. The process may then end, as at 216. If the storage targets are not exceeded, then the process may end (216) without taking any further action.

If, at 226, it is determined that adequate storage capacity is unavailable, excess gas may be diverted for disposal (e.g., flaring) and inventory may be updated, as at 232. It may then be determined whether the disposal techniques meet the environmental or governmental regulations, as at 234. If the disposal techniques meet the necessary regulations, then the gas is disposed and the process 200 exits, as at 216. Alternatively, the process 200 include revising the pressure management targets, updating the sales, and/or updating the reservoir model (or any other engineering model) taking into consideration the availability of excess gas, as at 222, before ending at 216.

As noted above, the process 200 is merely an example of how a flow of commodity may be balanced in a network 100 based on information communicated by the one or more commodity producers 102 and consumers 104, 108 included in the network 100. It will therefore be understood that the process 200 may be modified based on the application and design requirements.

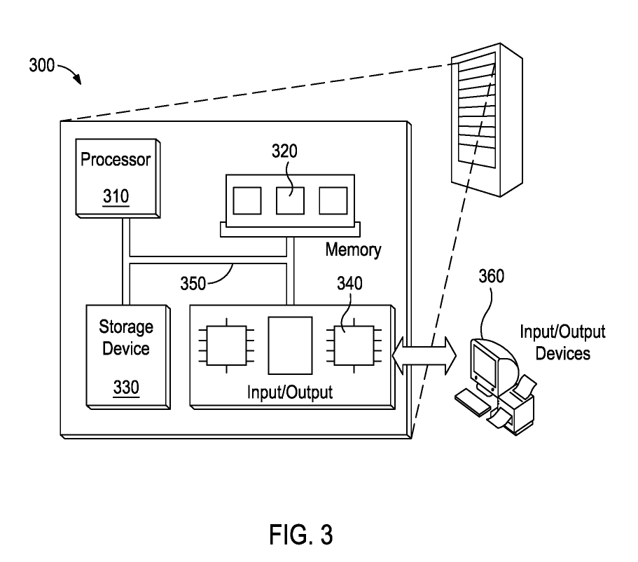

FIG. 3 illustrates an exemplary processing system 300 for configuring and/or controlling the operations of one or more of the commodity producers, the commodity consumers, and/or the separation and blending facilities in the network 100 of FIG. 1.

The system 300 may include a processor 310, a memory 320, a storage device 330, and an input/output device 340. Each of the components 310, 320, 330, and 340 may be interconnected, for example, using a system bus 350. The processor 310 may be processing instructions for execution within the system 300. In some embodiments, the processor 310 is a single-threaded processor, a multi-threaded processor, or another type of processor. The processor 310 may be capable of processing instructions stored in the memory 320 or on the storage device 330. The memory 320 and the storage device 330 can store information within the computer system 300.

The input/output device 340 may provide input/output operations for the system 300. In some embodiments, the input/output device 340 can include one or more network interface devices, e.g., an Ethernet card; a serial communication device, e.g., an RS-232 port; and/or a wireless interface device, e.g., an 802.11 card, a 3G wireless modem, or a 4G wireless modem. In some embodiments, the input/output device can include driver devices configured to receive input data and send output data to other input/output devices, e.g., keyboard, printer and display devices 360. In some embodiments, mobile computing devices, mobile communication devices, and other devices can be used.

In accordance with at least some embodiments, the disclosed methods and systems related to scanning and analyzing material may be implemented in digital electronic circuitry, or in computer software, firmware, or hardware, including the structures disclosed in this specification and their structural equivalents, or in combinations of one or more of them. Computer software may include, for example, one or more modules of instructions, encoded on computer-readable storage medium for execution by, or to control the operation of, a data processing apparatus. Examples of a computer-readable storage medium include non-transitory medium such as random access memory (RAM) devices, read only memory (ROM) devices, optical devices (e.g., CDs or DVDs), and disk drives.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative, or procedural languages. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be executed on one computer or on multiple computers that are located at one site or distributed across multiple sites and interconnected by a communication network.

Some of the processes and logic flows described in this specification may be performed by one or more programmable processors executing one or more computer programs to perform actions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors and processors of any kind of digital computer. Generally, a processor will receive instructions and data from a read-only memory or a random access memory or both. A computer includes a processor for performing actions in accordance with instructions and one or more memory devices for storing instructions and data. A computer may also include, or be operatively coupled to receive data from or transfer data to, or both, one or more mass storage devices for storing data, e.g., magnetic, magneto optical disks, or optical disks. However, a computer may not have such devices. Devices suitable for storing computer program instructions and data include all forms of non-volatile memory, media and memory devices, including by way of example semiconductor memory devices (e.g., EPROM, EEPROM, flash memory devices, and others), magnetic disks (e.g., internal hard disks, removable disks, and others), magneto optical disks, and CD-ROM and DVD-ROM disks. The processor and the memory can be supplemented by, or incorporated in, special purpose logic circuitry.

To provide for interaction with a user, operations may be implemented on a computer having a display device (e.g., a monitor, or another type of display device) for displaying information to the user and a keyboard and a pointing device (e.g., a mouse, a trackball, a tablet, a touch sensitive screen, or another type of pointing device) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A computer system may include a single computing device, or multiple computers that operate in proximity or generally remote from each other and typically interact through a communication network. Examples of communication networks include a local area network (“LAN”) and a wide area network (“WAN”), an inter-network (e.g., the Internet), a network comprising a satellite link, and peer-to-peer networks (e.g., ad hoc peer-to-peer networks). A relationship of client and server may arise by virtue of computer programs running on the respective computers and having a client-server relationship to each other.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C. As used herein, “real-time” refers to data processing that appears to take place, or actually takes place, instantaneously upon data acquisition or receipt of data.

What is claimed is:

1. A method comprising:
obtaining an available supply of a commodity using information provided by one or more commodity producers included in a network that also includes one or more commodity consumers;
obtaining a demand for the commodity using information provided by the one or more commodity consumers;
controlling the available supply of the commodity from the one or more commodity producers using information provided by the one or more commodity consumers; and
supplying the commodity to the one or more commodity consumers based on the demand for the commodity.

2. The method of claim 1, wherein the one or more commodity consumers include injection fluid suppliers, and wherein controlling the available supply of the commodity comprises revising an amount of the commodity supplied by the one or more commodity producers based on the information provided by the injection fluid suppliers, the information including an amount of injection fluid available for commodity production.

3. The method of claim 1, wherein the one or more commodity consumers include storage facilities, and wherein controlling the available supply of the commodity comprises revising an amount of the commodity supplied by the one or more commodity producers based on the information provided by the storage facilities, the information including an amount of the demanded commodity stored in the storage facilities.

4. The method of claim 1, wherein the one or more commodity consumers include commodity processing facilities, and wherein controlling the available supply of the commodity comprises revising an amount of the commodity supplied by the one or more commodity producers based on a processing capacity of the commodity processing facilities.

5. The method of claim 1, wherein the one or more commodity consumers includes injection fluid suppliers, storage facilities, and commodity processing facilities, and the method further comprises:
disposing the supplied commodity based on information obtained from one or more of the injection fluid suppliers, storage facilities, and commodity processing facilities.

6. The method of claim 1, wherein controlling the available supply of the commodity comprises reducing an amount of the commodity supplied to one or more other commodity consumers and increasing an amount of the commodity supplied to the one or more commodity consumers based on the demand of the commodity.

7. The method of claim 1, further comprising:
separating individual fluidic components from the supplied commodity or mixing the supplied commodity with one or more other commodities obtained from one or more other commodity producers to create one or more blended fluids; and
supplying the individual fluidic components or the one or more blended fluids to the one or more commodity consumers.

8. The method of claim 1, further comprising forecasting the demand for the commodity based on one or more delivery models.

9. The method of claim 1, further comprising:
forecasting, by the one or more commodity producers, changes to a quality of the commodity;
modifying one or more of the commodity consumers in response to the forecasted quality changes; and
processing the commodity having the forecasted quality changes.

10. The method of claim 1, further comprising:
forecasting, by the one or more commodity producers, changes to a quality of the commodity; and
reducing the supply to the one or more commodity consumers in response to the forecasted quality changes when the one or more commodity consumers cannot consume the commodity having the changed quality.

11. The method of claim 1, wherein the one or more commodity producers and the one or more commodity consumers comprise nodes of the network, and each node of the network periodically communicates an ability of the node to either deliver or consume the commodity to each of the other nodes of the network.

12. A system, comprising;
a network including one or more commodity producers and one or more commodity consumers, wherein the one or more commodity producers and the one or more commodity consumers comprise nodes of the network, and each node of the network periodically communicates information including an ability of the node to either deliver or consume a commodity to each of the other nodes of the network; and
a computer system including a processor and a non-transitory computer readable medium, the computer system being communicatively coupled to the one or more commodity producers and the one or more commodity consumers and the computer readable medium storing a computer readable program code that when executed by the processor causes the computer system to:
obtain an available supply of the commodity using information provided by the one or more commodity producers;
obtain a demand for the commodity using information provided by the one or more commodity consumers;
control the available supply of the commodity from the one or more commodity producers using information provided by the one or more commodity consumers; and
supply the commodity to the one or more commodity consumers based on the demand for the commodity.

13. The system of claim 12, wherein the one or more commodity consumers include injection fluid suppliers and wherein the program code further causes the computer system to control the available supply of the commodity by revising an amount of the commodity supplied by the one or more commodity producers based on the information provided by the injection fluid suppliers, the information including an amount of injection fluid available for commodity production.

14. The system of claim 12, wherein the one or more commodity consumers include storage facilities, and wherein the program code further causes the computer system to control the available supply of the commodity by revising an amount of the commodity supplied by the one or more commodity producers based on the information provided by the storage facilities, the information including an amount of the demanded commodity stored in the storage facilities.

15. The system of claim 12, wherein the one or more commodity consumers include commodity processing facilities, and wherein the program code further causes the computer system to control the available supply of the commodity by revising an amount of the commodity supplied by the one or more commodity producers based on a processing capacity of the commodity processing facilities.

16. The system of claim 12, wherein the one or more commodity consumers includes injection fluid suppliers, storage facilities, and commodity processing facilities, and wherein the program code further causes the computer system to control one or more commodity consumers to dispose the commodity supplied based on information obtained from one or more of the injection fluid suppliers, storage facilities, and commodity processing facilities.

17. The system of claim 12, wherein the program code further causes the computer system to control the available supply of the commodity by reducing an amount of the commodity supplied to one or more other commodity consumers and increasing an amount of the commodity supplied to the one or more commodity consumers based on the demand of the commodity.

18. The system of claim 12, wherein the program code further causes the computer system to:
separate individual fluidic components from the commodity supplied or mix the commodity supplied with one or more commodities obtained from one or more other commodity producers to create one or more blended fluids; and
supply the individual fluidic components or the one or more blended fluids to the one or more commodity consumers.

19. The system of claim 12, wherein the program code further causes the computer system to forecast the demand for the commodity based on one or more delivery models.

20. The system of claim 12, wherein the program code further causes the computer system to:
forecast changes in a quality of the commodity using the one or more commodity producers;
modify one or more of the commodity consumers in response to the forecasted changes in the quality of the commodity; and
process the commodity having the forecasted changes in quality.

21. The system of claim 12, wherein the program code further causes the computer system to:
forecast changes in a quality of the commodity using the one or more commodity producers; and
reducing the supply to the one or more commodity consumers in response to the forecasted changes in quality when the one or more commodity consumers cannot consume the commodity having the changed quality.
